(19) United States
(12) Patent Application Publication
(10) Pub. No.: US 2025/0235905 A1
(43) Pub. Date: Jul. 24, 2025

(54) DRAIN CLEANERS HAVING A STATIONARY BATTERY

(71) Applicant: Emerson Professional Tool, LLC, Elyria, OH (US)

(72) Inventors: Jeffrey Szucs, Ashland, OH (US); Alex Michael Cole, Columbia Station, OH (US)

(21) Appl. No.: 18/420,060

(22) Filed: Jan. 23, 2024

(51) Int. Cl. B08B 9/047

(52) U.S. Cl. CPC B08B 9/047

(57) ABSTRACT

A drain cleaner includes a drum that is rotatable about an axis of rotation that includes an annular drum channel for receiving a drain cleaning cable. A motor for rotating the drain cleaning cable rotates with the drum. The drain cleaner includes a battery for powering the motor. The motor is rotatable relative to the battery.

### FIELD

The field of the disclosure relates generally to drain cleaners and, more particularly, to drain cleaners having a stationary battery.

### BACKGROUND

High speed drain cleaners include a flexible cable enclosed within a non-rotating sheath. The cable and sheath typically are positioned inside an annular channel of a drum. The drum rotates when the cable is pulled out from the drum. An electric motor is typically used to rotate the drain cleaning cable during drain cleaning operations.

Some conventional high speed drain cleaners include a motor that rotates with the drum. The motor may be powered by a battery that also rotates with the drum. It is difficult to access the battery in conventional high speed drain cleaners as various housing components secured by fasteners must be removed. The battery is often disposed behind a front cover that originates typical drain cleaner controls (e.g., on/off, forward/reverse) that must be removed to access the battery.

A need exists for drain cleaners that are powered by a battery that is more accessible by an operator in the field.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a drain cleaner. The drain cleaner includes an outer drum and an inner drum positioned within the outer drum. The inner drum and outer drum are rotatable about an axis of rotation. The inner drum and the outer drum form an annular drum channel for receiving a drain cleaning cable. The inner drum defines an inner drum chamber. The drain cleaner includes a motor for rotating the drain cleaning cable. The motor is rotatable with the inner drum. The drain cleaner includes a battery for powering the motor. The motor is rotatable relative to the battery.

Another aspect of the present disclosure is directed to a drain cleaner. The drain cleaner includes a housing. An outer drum is positioned in the housing and an inner drum is positioned in the housing. The inner drum and outer drum are rotatable relative to the housing. The inner drum and the outer drum form an annular drum channel for receiving a drain cleaning cable. The inner drum defines an inner drum chamber. The drain cleaner includes a motor for rotating a drain cleaning cable. The motor is rotatable with the inner drum. A battery is positioned within the battery compartment.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a drain cleaner;

FIG. 2 is another perspective view of the drain cleaner;

FIG. 3 is a cross-section of the drum and the drum housing of the drain cleaner;

FIG. 4 is a perspective view of the drain cleaner showing the housing chamber in which electronic components are disposed;

FIG. 5 is a front view of the drain cleaner showing the inner drum chamber;

FIG. 6 is an exploded view of the drain cleaning cable and a cleaning head of the drain cleaner;

FIG. 7 is a detailed perspective view of the drain cleaner showing the front housing segment chamber of the drain cleaner;

FIG. 8 is another cross-section of the drum and the drum housing of the drain cleaner;

FIG. 9 is a perspective view of a rotary slip ring of the drain cleaner;

FIG. 10 is a block diagram of the power components and sensors of the drain cleaner;

FIG. 11 is a front view of the cable clamp and temperature sensor of the drain cleaner;

FIG. 12 is a perspective view of a position sensor for sensing the position of the cable clamp; and

FIG. 13 is a perspective view of the drain cleaner showing the battery compartment.

Corresponding reference characters indicate corresponding parts throughout the drawings.

### DETAILED DESCRIPTION

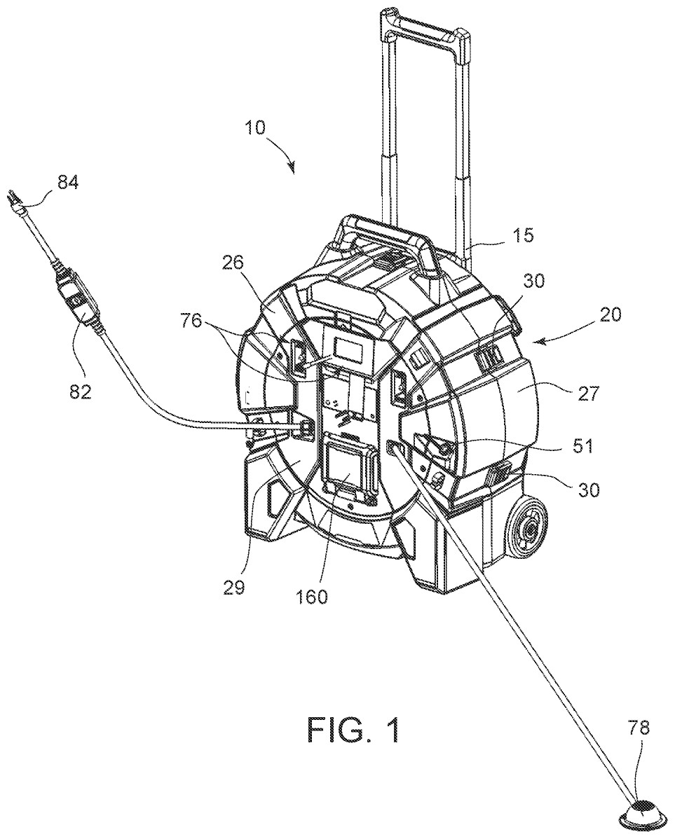

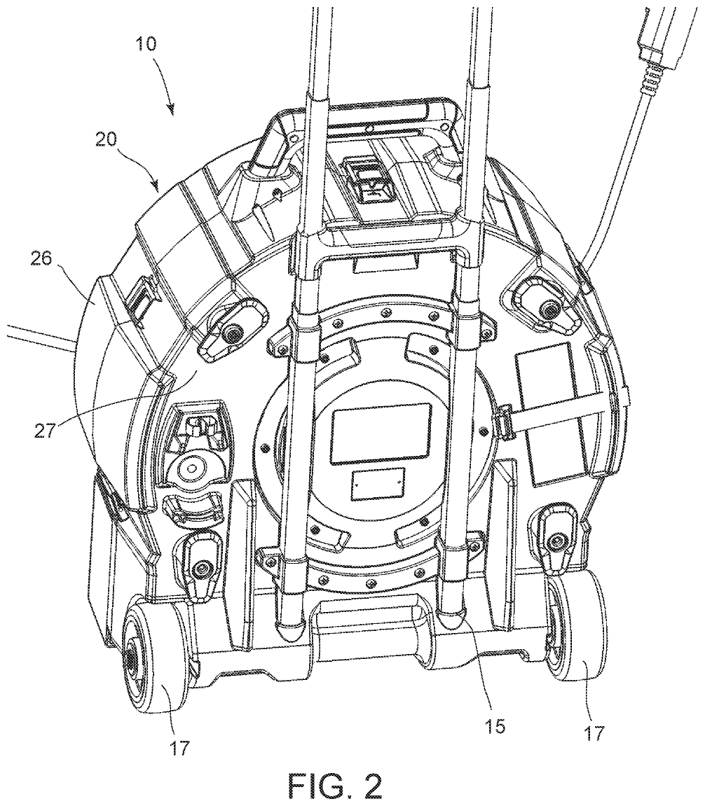

An embodiment of a drain cleaner 10 is shown in FIGS. 1-13. The drain cleaner 10 is shown in a vertical orientation and includes an optional cart 15. The drain cleaner 10 is selectively attachable, detachable, and/or releasable from the cart 15. The drain cleaner 10 includes at least one wheel 17 (FIG. 2) and typically utilizes two, four or six wheels. The drain cleaner 10 is typically operated in a horizontal orientation (e.g., may include a bearing that accommodates axial loads when the drain cleaner 10 is operated in a horizontal orientation). The drain cleaner 10 may include features and components disclosed in U.S. Patent Publication No. 2021/0172162, which is incorporated herein by reference for all relevant and consistent purposes.

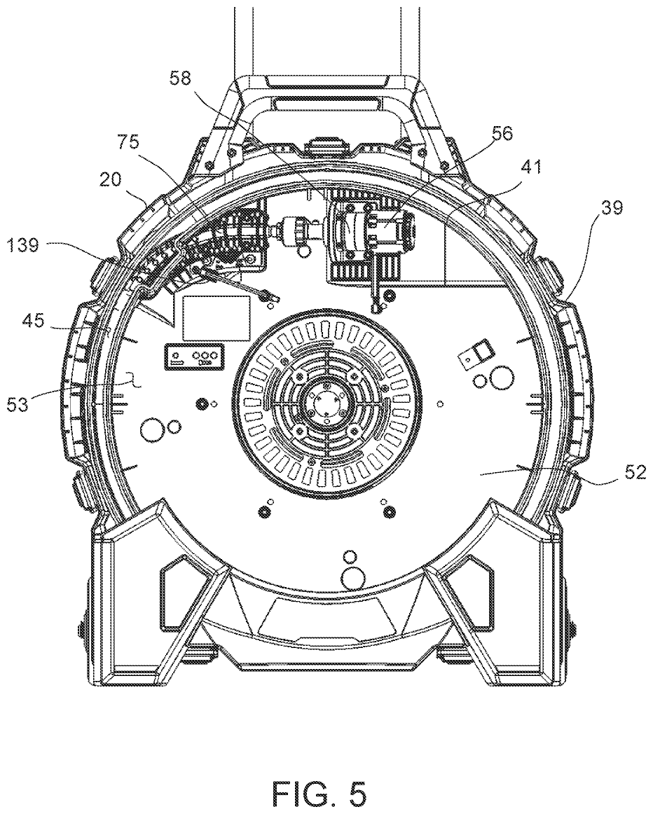

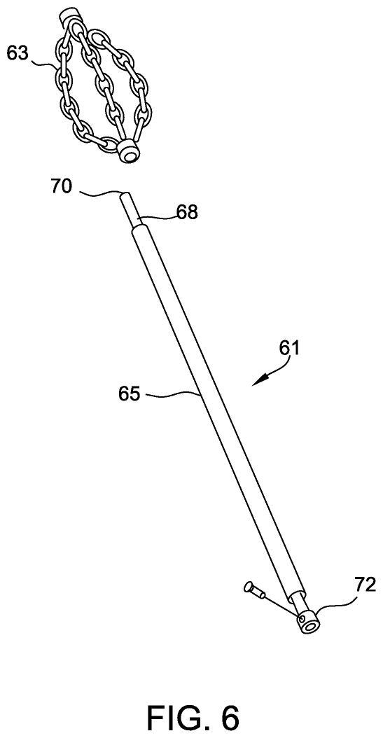

The drain cleaner 10 operates by rotating a cleaning head 63 (FIG. 6) as the cleaning head 63 moves through a drain. In the illustrated embodiment, the cleaning head 63 is connected to a drain cleaning cable 61 that includes a sheath 65 and a cable 68 positioned within the sheath 65. The cable 68 rotates relative to the sheath 65. The cable 68 connects to the cleaning head 63 at a distal end 70 of the cable 68. The cable 68 also connects to the output of a gear box 58 (FIG. 5) at a proximal end 72 of the cable 68. While the present disclosure describes a drain cleaning cable having a cable that rotates within a sheath, other types of drain cleaning cables could be used.

The drain cleaner 10 includes a drum housing 20 (FIG. 1). The drum housing 20 is generally cylindrical. The drum housing 20 includes a front housing segment 26 and a rear housing segment 27. The front housing segment 26 includes a front segment housing cover 29. The front housing segment 26 is removably connected to the rear housing segment 27 by latches 30.

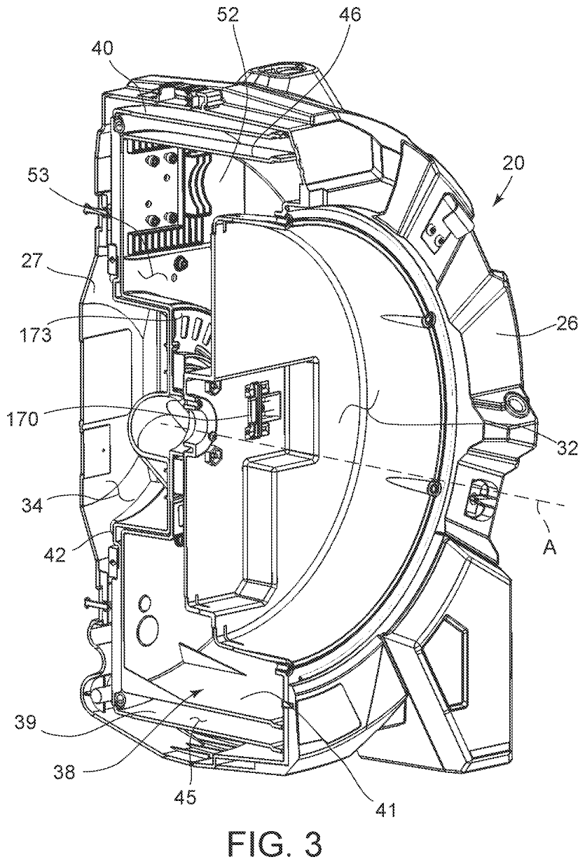

The cover 29 encloses a front housing Segment chamber 32 (FIG. 3) in which a various electronic components (e.g., motor controller and internal power supply) are disposed. The front housing segment 26 and the rear housing segment 27 form a housing chamber 34 in which a rotatable drum 38 is disposed.

The rotatable drum 38 includes an outer drum 39 and an inner drum 41 disposed within the outer drum 39. The inner drum 41 and outer drum 39 are rotatable relative to the drum housing 20 and rotate about axis A. The outer drum 39 and inner drum 41 are both cylindrically shaped. The inner drum 41 is concentrically positioned within the outer drum 39. The outer drum 39 and the inner drum 41 form an annular drum channel 45 for receiving the drain cleaning cable 61 (FIG. 6). The drain cleaning cable 61 is disposed within the annular drum channel 45 and moves in and out of the drum housing 20 (FIG. 1) as the inner drum 41 and outer drum 39 rotate. The drum housing 20 includes a cable port 51 through which the cable passes during cleaning operations of the drain cleaner 10.

The drain cleaner 10 may include drum support assemblies (not shown) that support the outer drum 39 and inner drum 41 and may include a bearing disposed between the primary and secondary support assemblies that enables the drum 38 to rotate relative to the housing 20.

The outer drum 39 includes an annular partition 40 and a basewall 42 that extends radially inward from the annular partition 40 toward the axis of rotation A of the inner drum 41. The inner drum 41 includes an annular partition 46 and a basewall 52 that extends radially inward from the annular partition 46 toward the axis of rotation A of the inner drum 41. The inner drum 41 defines an inner drum chamber 53 in which various components that rotate with the inner drum 41 are disposed.

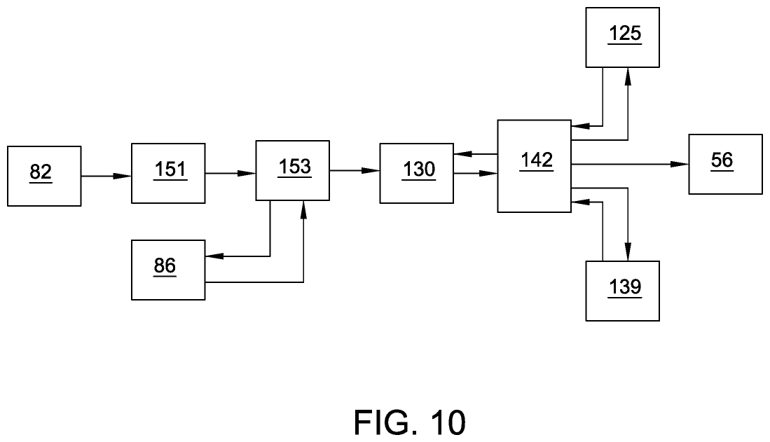

Referring now to FIG. 5, the drain cleaner 10 includes an electric motor 56 secured to the inner drum 41 and disposed within the inner drum chamber 53. The motor 56 rotates with the inner drum 41. In some embodiments, the drain cleaner 10 may include a counterweight secured to the inner drum 41 and disposed within the inner drum chamber 53. The drain cleaner 10 includes a gear box 58 connected to the motor 56 (e.g., connected to a rotary output of the motor 56). The gear box 58 rotates with the inner drum 41. The motor 56 may be controlled by a motor controller 130 (FIG. 10) as discussed further below. The motor controller 130 is stationary (does not rotate with the drum 38) and may be disposed in the front housing segment chamber 32 (FIG. 3).

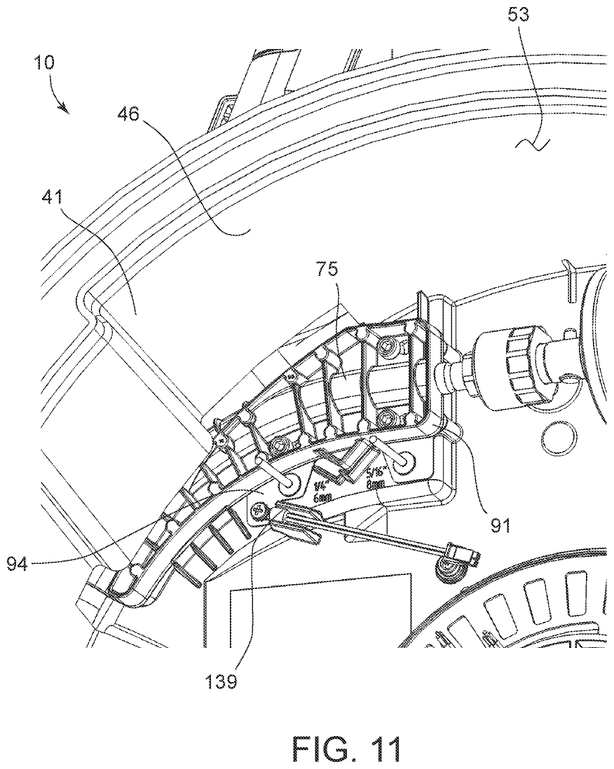

The drain cleaner 10 includes a cable clamp 75 (FIG. 11) secured to the inner drum 41 and disposed within the inner drum chamber 53. The cable clamp 75 is positioned over at least a region or portion of the drain cleaning cable 61 (FIG. 6). The cable clamp 75 rotates with the inner drum 41. The cable clamp 75 includes a main body 91 and a shield plate 94 disposed below the main body 91 which the cable being clamped between the main body 91 and shield plate 94.

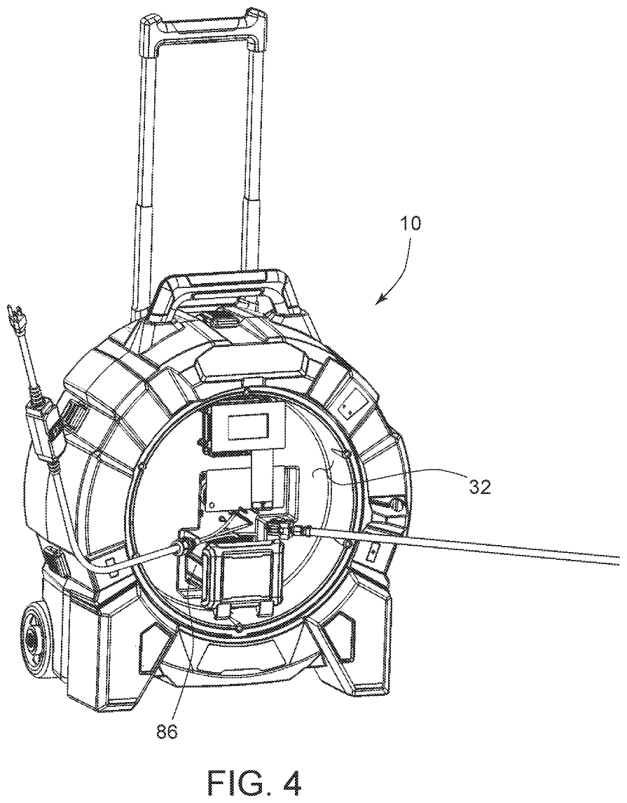

The drain cleaner 10 includes various controls and/or indicators 76 (FIG. 1). Specifically, the controls and indicators 76 can include one or more selector switches and electrical circuit breakers. The drain cleaner 10 may also optionally include a foot operated switch 78 for governing operation of the drain cleaner 10. The drain cleaner 10 includes components and circuitry for signal and/or power delivery between the housing cover 29 and the motor 56. The drain cleaner 10 includes a power cord assembly 82 having a plug 84 to connect the drain cleaner to mains power. The power cord assembly 82 also includes one or more switches and ground fault circuit interrupter (GFCI). The drain cleaner 10 also includes a battery 86 (FIG. 4) that may also be used to power the motor 56 (FIG. 5). The motor 56 is selectively powered (e.g., as determined by the controller) by mains power or by the battery.

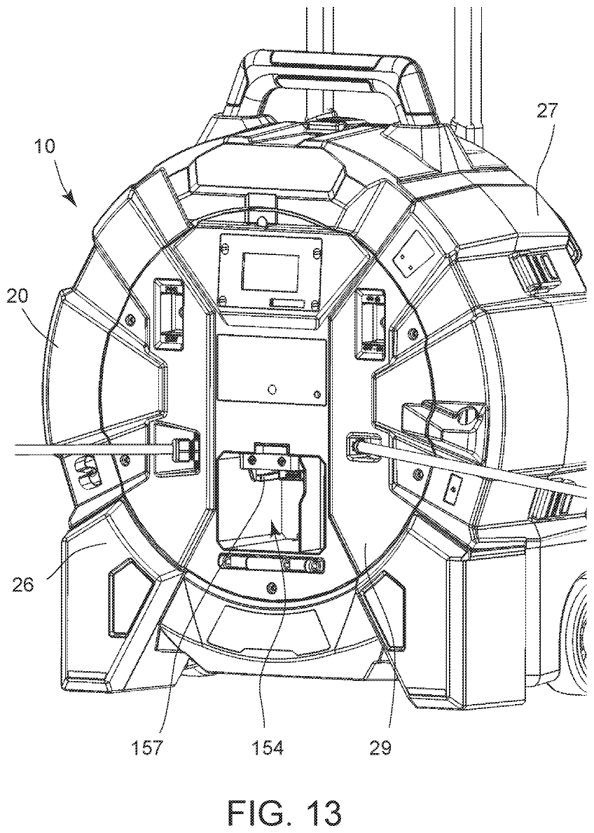

The battery 86 (FIG. 4) is stationary relative to the drum 38 (FIG. 3) and relative to the components that rotate with the drum 38, For example, the motor 56 (FIG. 5) rotates relative to the battery 86. In the illustrated embodiment, the battery 86 is external to the inner drum chamber 53 (FIG. 5). The battery 86 is removably disposed in a battery compartment 154 (FIG. 13) defined by the housing 20 and, in particular, the front housing segment 26. The battery compartment 154 is disposed in the housing chamber 34 (FIG. 3). The battery 86 is removably connected to the housing 20 by rails 157. The battery 86 may be enclosed in the battery compartment 154 by a removeable cover 160 (FIG. 1) which is hingedly connected to the housing 20. The battery 86 may be a rechargeable 18 volt battery (e.g., lithium ion).

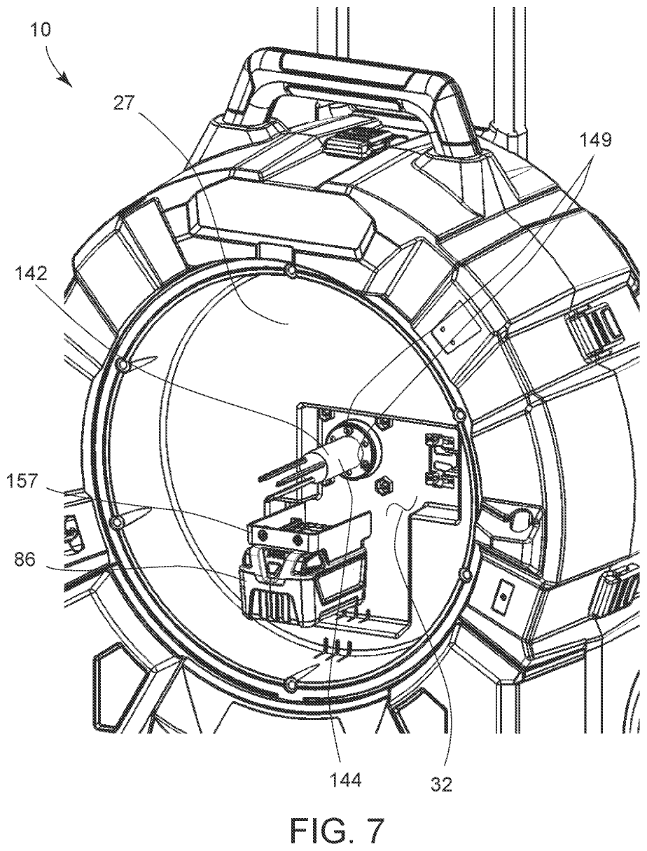

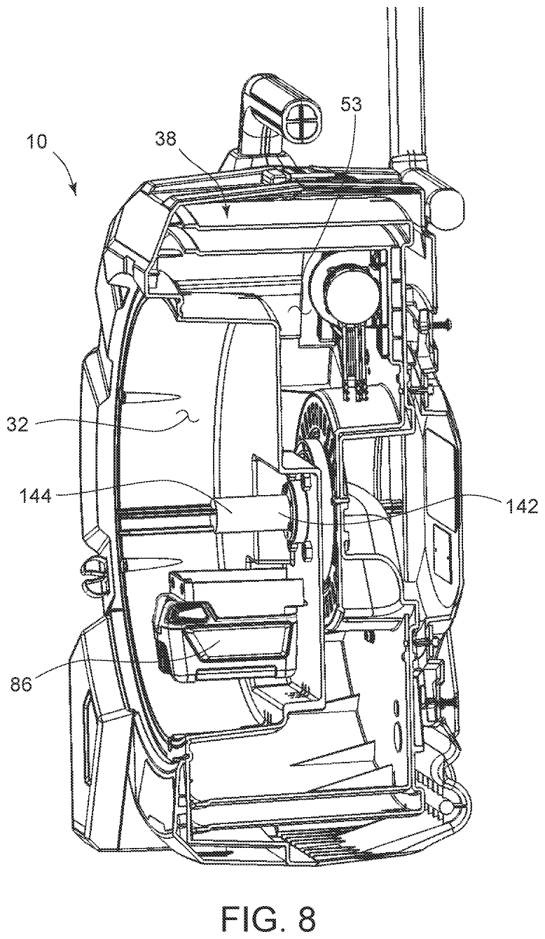

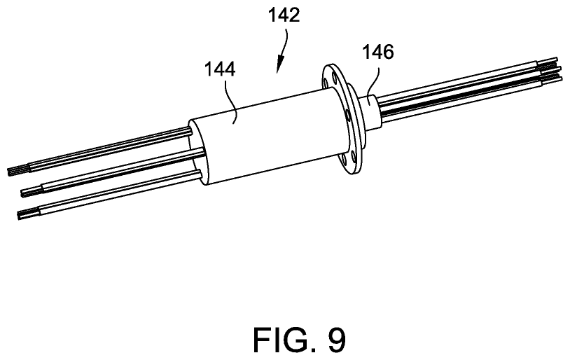

Referring now to FIGS. 7-9, the motor 56 (FIG. 5) is powered from the battery 86 or from mains power through a rotary slip ring 142. The rotary slip ring 142 includes a first portion 144 that is disposed within the front housing segment chamber 32 and a second portion 146 (FIG. 9) that is disposed in the inner drum chamber 53 (FIG. 8). The second portion 146 rotates relative to the first portion 144 and rotates with the drum 38. The first portion 144 is connected to the front housing segment 26 by fasteners 149.

The rotary slip ring 142 may include a number of electronically conductive spring-biased contacts within the first portion 144. The spring-biased contacts contact an electrically conductive cylinder that rotates with the first portion 144. The cylinder includes a series of grooves with each groove being connected to electrical wiring (e.g., for transfer of power or a communication signal). As the cylinder rotates, the conductive grooves contact the stationary contacts for transfer of power and signals between the stationary and rotating components of the drain cleaner 10.

The drain cleaner 10 includes an internal power supply 151 or more simply “power supply” (FIG. 10) which is configured to supply DC power to the motor 56. The power cord assembly 82 is connected to the internal power supply 151 and supplies AC power to the power supply 151. The power supply 151 converts AC power to DC power which is supplied to a charging printed circuit board assembly (PCBA) 153. The battery 86 connects to the charging PCBA 153. The charging PCBA connects to a motor controller 130. The motor controller 130 connects to the motor 56 through the rotary slip ring 142.

As shown in FIG. 10, the internal power supply 151 is operable to selectively (1) supply DC power to the motor 56 or (2) charge the battery 86 such as when the power cord assembly 82 is connected to mains power and the drain cleaner 10 is not being used for drain cleaning operations.

The internal power supply 151, charging PCBA 153, and motor controller 130 are stationary (do not rotate with the drum 38) and may be disposed in the front housing segment chamber 32 (FIG. 3). For the motor controller 130 to power the electric motor 56 which rotates with the drum 38, power is transferred through the rotary slip ring 142 (FIG. 10).

In some embodiments, the drain cleaner includes a temperature sensor 139 (FIG. 11). The temperature sensor 139 may be positioned within the inner drum chamber 53. In the illustrated embodiment, the temperature sensor 139 senses the temperature of the cable 61 (e.g., by sensing the temperature of the shield plate 94). As shown in FIG. 10, the temperature sensor 139 is connected to the motor controller 130 through the rotary slip ring 142.

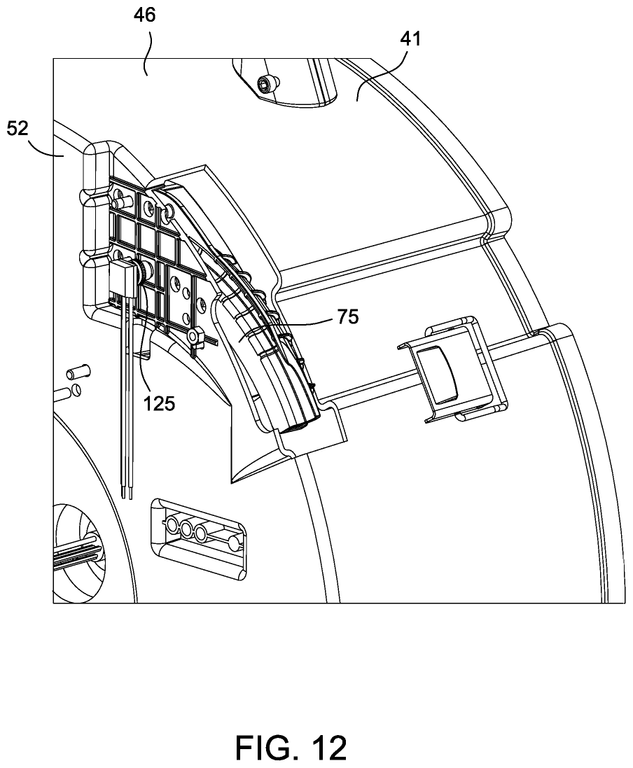

Alternatively or in addition, the drain cleaner 10 may include a position sensor 125 (FIG. 12) that senses the position of the cable clamp 75. The position sensor 125 is connected to the motor controller 130 through the rotary slip ring 142 (FIG. 10).

Compared to conventional high speed drain cleaners, the drain cleaners of embodiments of the present disclosure have several advantages. By using a stationary battery, the battery is more readily accessible by an operator in the field. A removable cover encloses the battery compartment which keeps debris from contacting the battery while providing access to the battery. The battery is secured within the battery compartment by rails which allow the battery to be easily removed and repositioned within the battery compartment. The rotary slip ring allows power to be transferred from the stationary battery or power cord (e.g., through the internal power supply) to the motor which rotates with the drum. The rotary slip ring allows communication from various rotating sensors (e.g., temperature and/or position sensors) to the stationary controller. By positioning the battery outside of the drum, the drum system can remain contained and is not exposed to the environment and contaminants and debris.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A drain cleaner comprising:
an outer drum;
an inner drum positioned within the outer drum, the inner drum and outer drum being rotatable about an axis of rotation, the inner drum and the outer drum forming an annular drum channel for receiving a drain cleaning cable, the inner drum defining an inner drum chamber; and
a motor for rotating the drain cleaning cable, the motor being rotatable with the inner drum; and
a battery for powering the motor, the motor being rotatable relative to the battery.

2. The drain cleaner as set forth in claim 1 comprising a rotary slip ring, the motor being powered through the rotary slip ring.

3. The drain cleaner as set forth in claim 2 comprising a power supply configured to supply DC power to the motor, the battery being connected to the power supply, the power supply powering the motor through the rotary slip ring.

4. The drain cleaner as set forth in claim 3 comprising a power cord for connecting the drain cleaner to mains power.

5. The drain cleaner as set forth in claim 4 wherein the power supply is operable to selectively (1) supply DC power to the motor, or (2) charge the battery.

6. The drain cleaner as set forth in claim 2 comprising:
a motor controller; and
a temperature sensor that rotates with the inner drum, the temperature sensor being connected to the motor controller through the rotary slip ring.

7. The drain cleaner as set forth in claim 2 comprising:
a motor controller;
a cable clamp that rotates with the inner drum; and
a position sensor for determining the position of the cable clamp, the position sensor being connected to the motor controller through the rotary slip ring.

8. The drain cleaner as set forth in claim 1 wherein the battery is a rechargeable battery.

9. The drain cleaner as set forth in claim 1 comprising a drain cleaning cable, the drain cleaning cable comprising a sheath and a cable positioned within the sheath, the cable being rotatable relative to the sheath.

10. The drain cleaner as set forth in claim 1 wherein the battery is external to the inner drum chamber.

11. A drain cleaner comprising:
a housing;
an outer drum positioned in the housing;
an inner drum positioned in the housing, the inner drum and outer drum being rotatable relative to the housing, the inner drum and the outer drum forming an annular drum channel for receiving a drain cleaning cable, the inner drum defining an inner drum chamber; and
a motor for rotating a drain cleaning cable, the motor being rotatable with the inner drum; and
a battery removably connected to the housing.

12. The drain cleaner as set forth in claim 11 wherein the housing defines a battery compartment, the battery being disposed within the battery compartment.

13. The drain cleaner as set forth in claim 12 wherein the housing comprises a front housing segment and a rear housing segment, the front housing segment forming the battery compartment.

14. The drain cleaner as set forth in claim 13 wherein the front housing segment and the rear housing segment are removably connected by latches.

15. The drain cleaner as set forth in claim 12 further comprising a removeable cover connected to the battery compartment.

16. The drain cleaner as set forth in claim 11 wherein the housing comprises a housing chamber, the drain cleaner comprising a rotary slip ring that extends from the housing chamber into the inner drum chamber, the motor being powered through the rotary slip ring.

17. The drain cleaner as set forth in claim 16 comprising an power supply configured to supply DC power to the motor, the power supply being positioned within the housing chamber, the battery being connected to the power supply, the power supply powering the motor through the rotary slip ring.

18. The drain cleaner as set forth in claim 17 comprising a power cord for connecting the drain cleaner to mains power.

19. The drain cleaner as set forth in claim 18 wherein the power supply is operable to selectively (1) supply DC power to the motor or (2) charge the battery.

20. The drain cleaner as set forth in claim 11 comprising a drain cleaning cable, the drain cleaning cable comprising a sheath and a cable positioned within the sheath, the cable being rotatable relative to the sheath.
